(19) United States
(12) Patent Application Publication
(10) Pub. No.: US 2007/0086474 A1
(43) Pub. Date: Apr. 19, 2007

(54) Method for estimating a map size in a wireless mobile communication system

(75) Inventors: Hee-Kwang Lee, Suwon-si (KR); Jung-Won Kim, Seoul (KR); Yoo-Seung Song, Yongin-si (KR)

Correspondence Address: DILWORTH & BARRESE, LLP, 333 EARLE OVINGTON BLVD., SUITE 702, UNIONDALE, NY, 11553, US

(73) Assignee: SAMSUNG ELECTRONICS CO., LTD., Suwon-si (KR)

(21) Appl. No.: 11/580,794

(22) Filed: Oct. 13, 2006

(30) Foreign Application Priority Data
Oct. 13, 2005 (KR) 96623/2005

(51) Int. Cl. H04L 12/413

(52) U.S. Cl. 370/447; 370/468

(57) ABSTRACT

A method is provided for estimating the size of a MAP region according to data burst allocation in a wireless mobile communication system. A data burst region is divided into at least one sub-region. A downlink frame is constructed with at least one sub-region such that a power boosting process is performed according to a predefined power level. The data burst is allocated to a specific sub-region of the sub-region according to a carrier to interference and noise ratio (CINR) of the data burst. A slot occupancy rate of data bursts allocated to the specific sub-region is computed. A concatenation or non-concatenation of the data bursts is set according to a predetermined criterion when the slot occupancy rate is less than a predefined slot occupancy rate. A size of the MAP region to be occupied by allocation information of the data bursts to be concatenated or unconcatenated is set.

### PRIORITY

This application claims priority under 35 U.S.C. § 119 to an application filed in the Korean Intellectual Property Office on Oct. 13, 2005 and assigned Serial Number 2005-96623, the contents of which are incorporated herein by reference.

### BACKGROUND OF THE INVENTION

1. Field of the Invention

The present invention generally relates to a wireless mobile communication system, and more particularly to a method for estimating a downlink MAP size in a wireless mobile communication system.

2. Description of the Related Art

A large amount of research is being conducted aimed at providing users with services based on various qualities of service (QoS) at a high transmission rate in fourth-generation (4G) communication systems serving as next-generation communication systems, for example, about 100 Mbps. In the current 4G-communication system, active research is being conducted to support a high-speed service for ensuring mobility and QoS in broadband wireless access (BWA) communication systems such as wireless local area network (LAN) and metropolitan area network (MAN) communication systems as specified by the Institute of Electrical and Electronics Engineers (IEEE) 802.16 communication system.

IEEE 802.16 communication system applies an Orthogonal Frequency Division Multiplexing/Orthogonal Frequency Division Multiple Access (OFDM/OFDMA) scheme to a physical channel of the wireless MAN system in order to support a broadband transmission network. The OFDM/OFDMA scheme can obtain optimal transmission efficiency at the time of transmitting high-speed data by maintaining orthogonality between multiple sub-carriers. Further, the OFDM/OFDMA scheme has good frequency use efficiency and robustness to multi-path fading, thereby obtaining optimal transmission efficiency at the time of transmitting high-speed data. Also, a wireless broadband (WiBro) system of a mobile Internet service in the 2.3 GHz band employs the OFDM scheme.

On the other hand, a communication system using the OFDMA scheme should appropriately distribute and use resources to increase channel availability between mobile stations (MSs) and a base station (BS). One of the resources capable of being shared in the communication system using the OFDMA scheme is a sub-carrier. Optimal channel availability is achieved according to how to generate a sub-carrier channel and allocate sub-carriers to MSs within a cell.

A data transmission of a wireless mobile communication system is performed in a frame unit. Each frame is divided into a region in which downlink (DL) data can be transmitted and a region in which uplink (UL) data can be transmitted. The UL and DL data regions are sub-divided along frequency and time axes. In a two-dimensional plot of the frequency and time axes, each element is referred to as a slot.

Thus, the BS designates DL data burst allocation information of the MS in a DL-MAP region of a DL frame. Data bursts are allocated to the DL data region while occupying multiple time slots. According to the wireless mobile communication system standard, i.e., the IEEE 802.16 specification, resource allocation information is recorded in a MAP region with a fixed size when the BS allocates DL resources. Because the BS sets a size of a data burst allocation region and the number of data bursts to be allocated using a fixed number of DL-MAP information elements (IEs), the resource availability and efficiency may be degraded.

### SUMMARY OF THE INVENTION

Accordingly, the present invention has been designed to solve the above and other problems occurring in the prior art. Therefore, it is an object of the present invention to provide a method for estimating a MAP size to maximize the resource availability in a wireless mobile communication system.

In accordance with an aspect of the present invention, there is provided a method for estimating a size of a broadcast information (MAP) region according to data burst allocation in a wireless mobile communication system in which a downlink (DL) frame is divided in slots of time and frequency resources and a data burst is transmitted to a mobile station including dividing a region to which a data burst is allocated into at least one data burst sub-region and constructing the DL frame with at least one data burst sub-region such that a power boosting process is performed according to a predefined power level; allocating the data burst to a specific data burst sub-region of at least one data burst sub-region according to a carrier to interference and noise ratio (CINR) of the data burst; computing a slot occupancy rate of data bursts allocated to the specific data burst sub-region; setting a concatenation or non-concatenation of the data bursts allocated to the specific data burst sub-region according to a predetermined criterion when the slot occupancy rate is less than a predefined slot occupancy rate; and estimating a size of the MAP region to be occupied by allocation information of the data bursts to be concatenated or unconcatenated by the setting.

### BRIEF DESCRIPTION OF THE DRAWINGS

The above and other objects, features and advantages of the present invention will be more clearly understood from the following detailed description taken in conjunction with the accompanying drawings, in which:

FIG. 1 illustrates a structure of a downlink frame in a wireless mobile communication system in accordance with the present invention;

FIG. 2 is a flowchart illustrating a resource allocation process in the wireless mobile communication system in accordance with the present invention;

FIG. 3 illustrates data burst allocation in a data burst region divided into multiple regions in the wireless mobile communication system in accordance with the present invention;

FIGS. 4A and 4B are a flowchart illustrating a process for estimating a MAP size and allocating a data burst in a base station in accordance with the present invention; and

FIG. 5 illustrates a process for constructing one data burst by controlling data bursts in the wireless mobile communication system in accordance with the present invention.

### DETAILED DESCRIPTION OF THE PREFERRED EMBODIMENTS

Preferred embodiments of the present invention will be described in detail herein below with reference to the accompanying drawings. In the following description, detailed descriptions of functions and configurations incorporated herein that are well known to those skilled in the art are omitted for clarity and conciseness.

The present invention provides a method for estimating a variable MAP size according to downlink (DL) data burst allocation in a wireless mobile communication system. A DL frame is divided into a preamble region, a MAP region, and a data burst allocation region. The data burst allocation region can be configured without applying power boosting or deboosting. Alternatively, the data burst allocation region can include at least one data burst sub-region to which power boosting or deboosting is applied. The MAP region includes allocation information about a position of data burst allocated to the data burst allocation region.

For example, when the number of data bursts to be allocated to the data burst allocation region is large, the amount of allocation information to be included in the MAP region increases. However, if an information amount of data bursts to be allocated is more than a size of the MAP region because the size of the MAP region is conventionally fixed, the data burst should be allocated to the next DL frame. If the information amount of data bursts to be allocated is less than the size of the MAP region, the amount of remaining radio resources of the MAP region is not used for any purpose. The present invention maximizes the radio resource availability by variably estimating the MAP size according to the number of data bursts to be allocated.

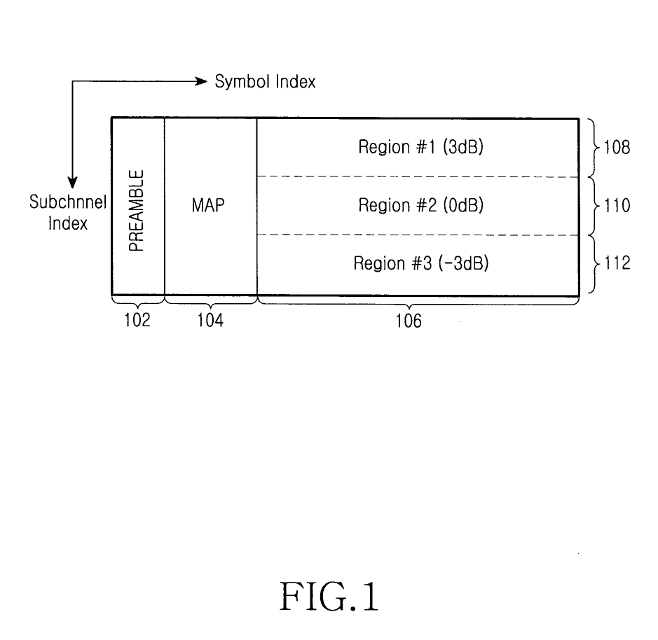

FIG. 1 illustrates a structure of a DL frame in a wireless mobile communication system in accordance with an exemplary embodiment of the present invention.

Referring to FIG. 1, the DL frame is divided into a preamble region 102, a MAP region 104, and a data burst allocation region 106. The preamble region 102 includes a preamble for synchronization acquisition. The MAP region 104 is provided with a DL MAP and a UL MAP including broadcast data information to be commonly received between mobile stations (MSs). DL data bursts to be transmitted to the MSs are allocated to the data burst allocation region 106. Position and allocation information of the DL data bursts is included in the DL MAP of the MAP region 104.

In the data burst allocation region 106, the horizontal axis represents a time or symbol index and the vertical axis represents a frequency or subchannel index. In the present invention, the data burst allocation region 106 divided along the symbol and frequency axes is sub-divided into data burst allocation sub-regions 108 to 112 to which power boosting or deboosting is applied. In FIG. 1, the data burst allocation region 106 is divided into three data burst sub-regions, i.e., Region#1 108, Region#2 110, and Region#3 112. A 3 dB power boosting process is applied to data bursts allocated to Region#1 108. A 0 dB power boosting process is applied to data bursts allocated to Region#2 110. A −3 dB power boosting process is applied to data bursts allocated to Region#3 112. Of course, the data burst region can be divided into at least one data burst sub-region. That is, the prior art performs the power boosting or deboosting process for respective data bursts, whereas the present invention performs the power boosting or deboosting process on a sub-region-by-sub-region basis by dividing a region to which data bursts are allocated.

The data burst region is divided into two data burst sub-regions (i.e., a 3 dB power boosting region and a −3 dB power boosting region) or three data burst sub-regions (i.e., a 3 dB power boosting region, a 0 dB power boosting region, and a −3 dB power boosting region). In the sub-regions, full usage of subchannel (FUSC) and partial usage of subchannel (PUSC) zones can be used.

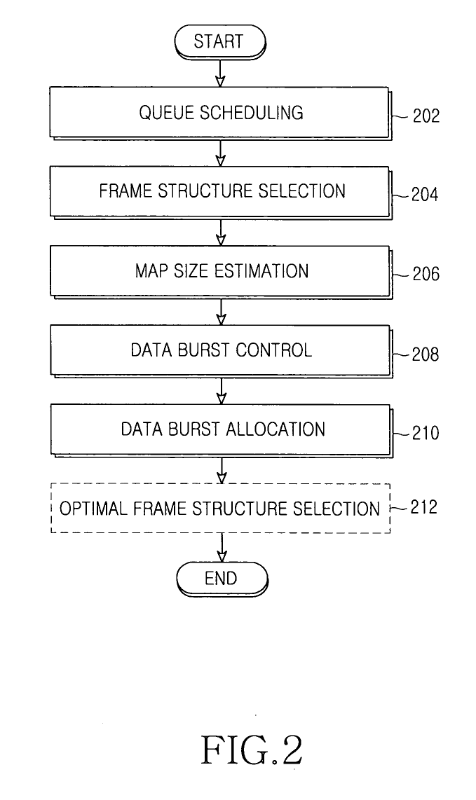

FIG. 2 is a flowchart illustrating a resource allocation process in the wireless mobile communication system in accordance with an exemplary embodiment of the present invention.

Data bursts can be classified in an integer number of slots. When a two-dimensional allocation process based on the frequency and time is performed for the data bursts, slots should be not wasted in the DL frame. The DL frame is divided along the frequency axis and the symbol (or time) axis. Multiple slots considering both the frequency and the time are present in the DL frame.

Referring to FIG. 2, a base station (BS) performs a queue scheduling process for setting priorities on a connection-by-connection basis with respect to data bursts to be transmitted on a service class-by-service class basis in step 202 and then proceeds to step 204. The BS determines how to divide the data burst allocation region 106 of the DL frame and selects a frame structure mapped to a division method in step 204 and then proceeds to step 206. Herein, the frame structure can have a predefined fixed format and can have a variable format according to characteristics of data bursts to be transmitted. As illustrated in FIG. 1, a data burst region can have a frame structure divided into a plurality of data burst sub-regions.

The BS sets a MAP size by estimating the MAP overhead needed for the data bursts to be transmitted in step 206 and then proceeds to step 208. The MAP size should be set large when the number of data bursts to be transmitted is large. However, when the MAP size is set large, the size of the data burst region becomes relatively small in the frame. Thus, the MAP size and the data burst region size should be suitably set to maximize the radio resource availability.

To minimize the MAP overhead, the BS constructs one data burst by controlling data bursts to be transmitted to the same MS or data bursts with the same modulation and coding scheme (MCS) level in step 208. Then, the BS proceeds to step 210. MCSs are combinations of modulation schemes and coding schemes. According to the number of MCSs, multiple MCSs from Level 1 to Level N can be defined.

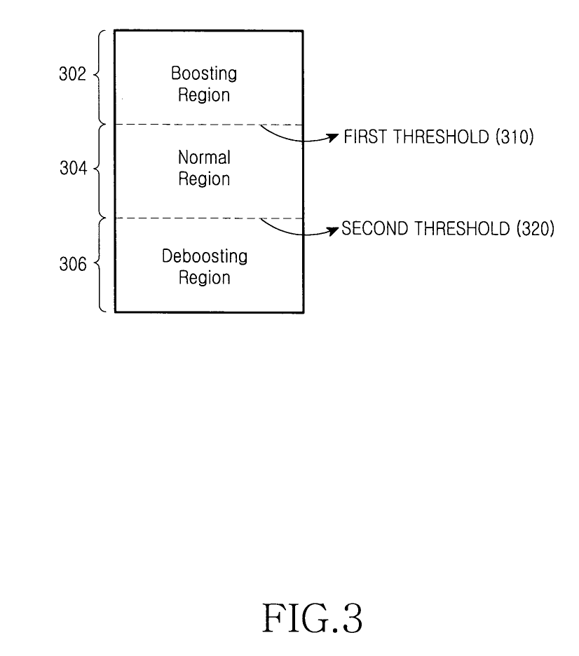

In step 210, the BS allocates data bursts input in order of transmission priorities to specific data burst sub-regions of the data burst region of the DL frame and according to a predetermined rule. Then, the BS proceeds to step 212. The predetermined rule will be described in detail with reference to FIG. 3.

In step 212, the BS sets a frame structure with the highest resource availability to an optimal frame structure according to data bursts allocated by repeating steps 206 to 210. In step 204, one frame structure can be selected to reduce the implementation complexity. In this case, step 212 can be omitted.

FIG. 3 illustrates data burst allocation in a data burst region divided into multiple regions in the wireless mobile communication system in accordance with an exemplary embodiment of the present invention.

Referring to FIG. 3, the data burst region is divided into three data burst sub-regions of a boosting region 302, a normal region 304, and a deboosting region 306.

If the carrier to interference and noise ratio (CINR) value of a data burst to be allocated is less than a first threshold 310, the data burst is allocated to the boosting region 302. If the CINR value is more than a second threshold 320, the data burst is allocated to the deboosting region 306. If the CINR value is more than the first threshold and is less than the second threshold, the data burst is allocated to the normal region 304. Herein, the CINR value of the data burst is a value previously fed back from an MS when a channel state between the MS and a BS is measured. An MCS level is set using the CINR value. When transmitting a first data burst for which a CINR value fed back from the MS is absent, the BS can transmit the first data using the most robust MCS. When the MCS level for a data burst allocated to the normal region 304 does not change after the −3 dB power boosting process, the data burst is re-allocated to the deboosting region 306. That is, because the MCS level does not change even though the −3 dB power boosting process is applied to the data burst re-allocated to the deboosting region 306, its frequency efficiency is the same as that before the −3 dB power boosting process. Thus, the spare power is minimized and therefore the total power efficiency is improved.

Similarly, when the MCS level for a data burst allocated to the boosting region 302 does not change after the 3 dB power boosting process, the data burst is re-allocated to the normal region 304. That is, because the MCS level does not change even though the 3 dB power boosting process is applied to the data burst re-allocated to the normal region 304, its frequency efficiency is the same as that before the 3 dB power boosting process. Thus, the spare power is minimized and therefore the total power efficiency is improved.

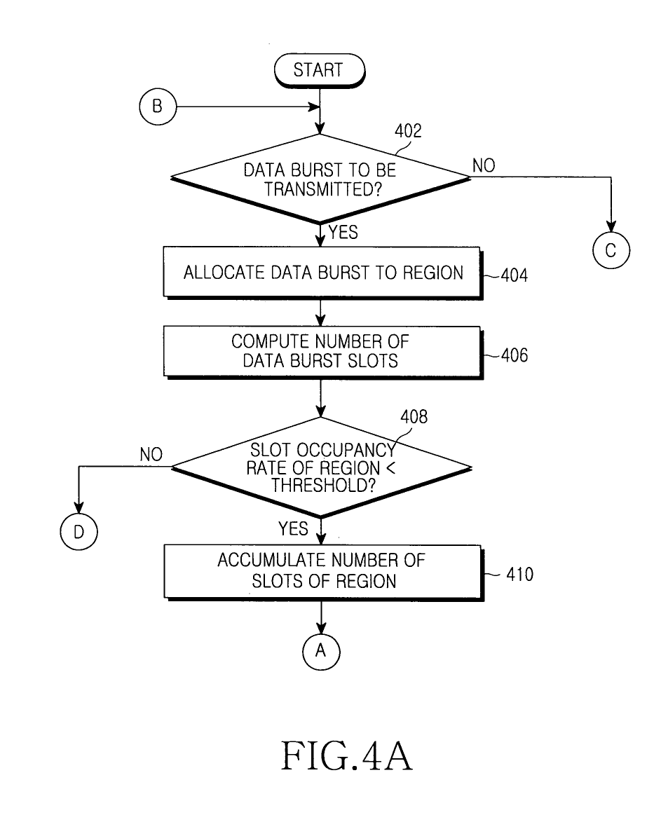

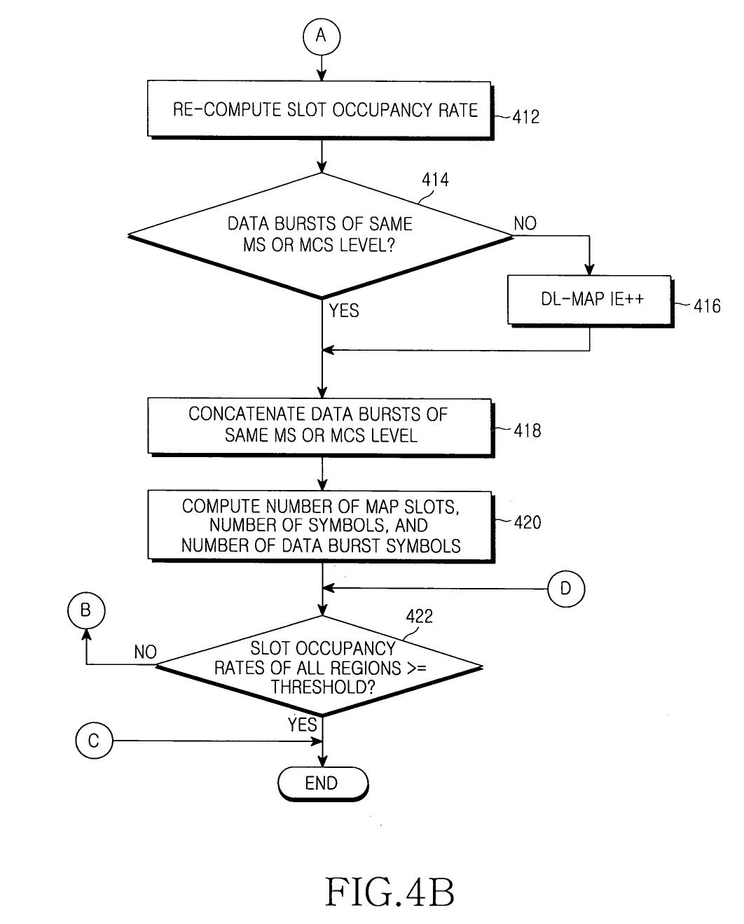

FIGS. 4A and 4B are a flowchart illustrating a process for estimating a MAP size and allocating a data burst in a BS in accordance with an exemplary embodiment of the present invention.

Referring to FIGS. 4A and 4B, the BS proceeds to step 404 if a data burst to be transmitted is present in step 402. The BS allocates the data burst to one of at least two data burst sub-regions according to a CINR value thereof in step 404 and then proceeds to step 406. Because the method for allocating the data burst to the data burst sub-region has been described with reference to FIG. 3, its description is omitted.

The BS computes the number of slots for data bursts on an MS-by-MS basis in step 406 and then proceeds to step 408. In step 408, the BS compares the slot occupancy rate of an associated data burst sub-region with the slot occupancy rate threshold of the predefined data burst sub-region to detect a spare slot to which a data burst can be allocated. If the slot occupancy rate threshold is more than the slot occupancy rate of the associated data burst sub-region, the BS proceeds to step 410. Otherwise, the BS proceeds to step 422 of FIG. 4B. Herein, the slot occupancy rate of the data burst sub-region can be defined as the number of slots occupied by the current data bursts to the total number of slots of the associated data burst sub-region. Further, the slot occupancy rate threshold is a value suitably set in the system, and can be set to, for example, 100%.

The BS computes the cumulative number of slots occupied by the data bursts in the associated data burst sub-region in step 410 and then proceeds to step 412. The BS re-computes a slot occupancy rate of the data burst sub-region to which the data bursts are allocated in step 412 and then proceeds to step 414. If the data burst to be transmitted is the data burst of the same MS in the same data burst sub-region or has the same MCS level as an already allocated data burst in the same data burst sub-region to reduce MAP overhead in the BS in step 414, the BS proceeds to step 418. However, if the data burst to be transmitted is not the data burst of the same MS or has not the same MCS level as the already allocated data burst, the BS proceeds to step 416.

The BS increments the number of DL-MAP IEs in step 416 and then proceeds to step 418. The BS concatenates data bursts on an MS-by-MS basis or concatenates data bursts of the same MCS level to construct one data burst in step 418 and then proceeds to step 420. The BS computes the number of MAP slots, the number of MAP symbols, and the number of data burst symbols in step 420 as shown in Equation (1) and then proceeds to step 422. If the number of DL-MAP IEs does not increase, the number of MAP slots, the number of MAP symbols and the number of data burst symbols do not increase. For example, Equation (1) is used to estimate the MAP size in a criterion of PUSC.
Number of MAP slots=4+39+4×UL_MAP IE count+4.5×DL_MAP IE count+4×DL_STC ZONE IE+3×UL_STC ZONE IE
Number of MAP symbols=ceiling (Number of MAP slots/30)×2
Number of Data burst symbols=Number of Frame symbols−(Number of Preamble symbols (1)+Number of MAP symbols) 1

In the formula for computing the number of MAP slots in Equation (1), 4 is the number of slots needed to transmit information bits of a frame control header (FCH) in the MAP; 39 is the number of slots needed to transmit additional information bits, for example, information bits of a MAP message length, an operator identifier, a sector identifier, a PHY (PHYsical) synchronization field, and so on. A coefficient 4 of the UL_MAP IE count is the number of slots needed to transmit position and MCS level information of a UL burst. A coefficient 4.5 of the DL_MAP IE count is the number of slots needed to transmit position and MCS level information of a DL burst. A coefficient 4 of the DL_STC ZONE IE is obtained by computing the number of information bits in a slot unit when at least one of PUSC and FUSC zones is used in a DL sub-frame. A coefficient 3 of the UL_STC ZONE IE is obtained by computing the number of information bits in the slot unit when at least one of the PUSC and FUSC zones is used in a UL sub-frame. Herein, if at least one zone is used, it means that a preamble is placed at the beginning of the DL sub-frame and subsequently the PUSC zone is used in the DL sub-frame. When the PUSC zone is continuously used in the next data burst region, a DL_STC ZONE IE is not needed. Thus, a DL_STC ZONE IE value becomes 0. However, when a burst is allocated to the data burst region in FUSC mode, one DL_STC ZONE IE is needed. That is, the DL_STC ZONE IE is needed at every permutation change time after the MAP region. Similarly, this is applied also to the UL sub-frame region. Equation (1) is an example to estimate the MAP size. As the amount of information, i.e., the number of IEs, is changed, the equation should be changed. For example, 4.5 slots per DL burst are needed. When the connection identifier (CID) designates the MAP, 2 slots per CID are needed. Only a fast feedback allocation IE and a Hybrid Automatic Repeat Request (HARQ) region allocation IE are considered in Equation (1). Alternatively, other IEs may be added according to a call scenario such as Code Division Multiple Access (CDMA) allocation IE, Peak to Average Power Ratio (PAPR) reduction and safety zone allocation IE, and so on.

The number of DL_MAP IEs and the number of UL_MAP IEs are set according to allocation information of DL_MAP and UL_MAP data bursts to be transmitted. When a data burst is allocated using Equation (1), the number of symbols of the MAP region and the number of symbols of the data burst region are set. The number of slots per two symbols is 30 in the PUSC frame and the number of slots per symbol is 16 in the FUSC frame. When computing the number of MAP symbols and the number of data burst symbols, the BS can allocate the data burst to a data burst sub-region. In Equation (1), STC stands for space-time coding and is used to obtain transmit diversity gain in the DL. Conventionally, the preamble region of the DL frame is constructed with one symbol. In the interval of one frame, the number of UL_MAP and DL_MAP IEs is set by the number of UL and DL data bursts to be transmitted therein. Of course, the number of DL_MAP IEs can change by concatenating or unconcatenating data bursts in the present invention.

In step 422, the BS compares whether the slot occupancy rate of each data burst sub-region is more than the slot occupancy rate threshold. If the slot occupancy rates of all data burst sub-regions are more than the slot occupancy rate threshold, data burst allocation is stopped. Otherwise, the process is repeated from step 402.

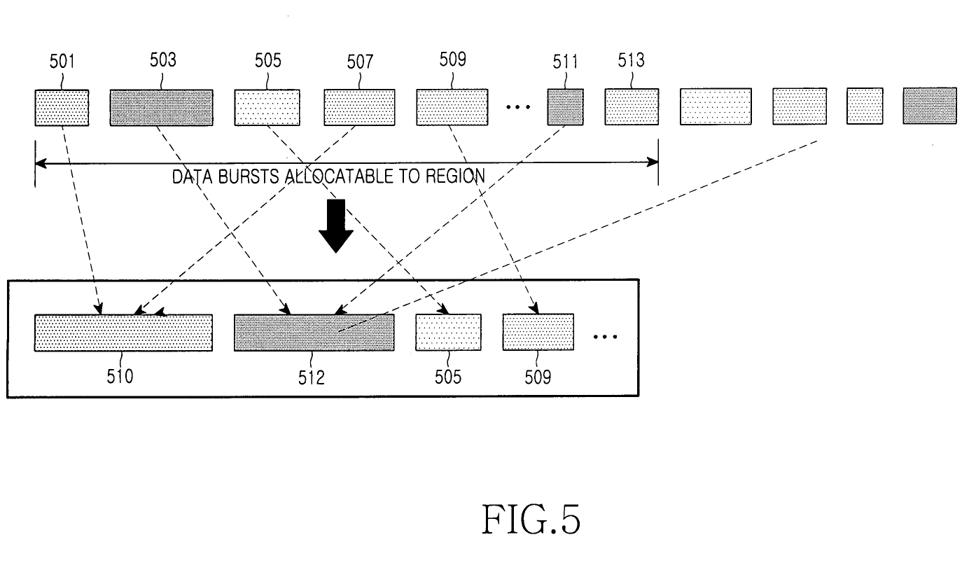

FIG. 5 illustrates a process for constructing one data burst by controlling data bursts in the wireless mobile communication system in accordance with an exemplary embodiment of the present invention.

Referring to FIG. 5, data bursts to be transmitted to the same MS or data bursts with the same MCS level can be constructed in one group. That is, data bursts 501, 503, 505, 507, 509, 511, and 513 are arranged and allocated in order of priorities. The data bursts 501, 507, and 513 may be data bursts of the same MS or data bursts of the same MCS level. Thus, the data bursts are concatenated and constructed in one data burst as a data burst 510. Similarly, the data bursts 503 and 511 are concatenated and constructed in one data burst as a data burst 512.

On the other hand, the data burst 501 to 513 can be allocated in one DL frame. Subsequent data bursts can be allocated in the next DL frame. When scattered data bursts are constructed in one data burst according to the same MS or the same MCS level, a DL_MAP IE size for data burst allocation information is reduced. This means that a MAP region size is reduced. As the MAP region size is reduced, the size of a data burst region to which data bursts can be allocated increases.

As is apparent from the above description, the present invention can maximize the resource availability and efficiency in the overall system by efficiently allocating a data burst to a data burst allocation region of a DL frame including a data burst sub-region to which a predetermined power boosting process is applied in a wireless mobile communication system.

Although the preferred embodiments of the present invention have been disclosed for illustrative purposes, those skilled in the art will appreciate that various modifications, additions, and substitutions are possible, without departing from the scope of the present invention. Therefore, the present invention is not limited to the above-described embodiments, but is further defined by the following claims.

What is claimed is:

1. A method for estimating a size of a broadcast information (MAP) region according to data burst allocation in a wireless mobile communication system in which a downlink (DL) frame is divided in slots of time and frequency resources and a data burst is transmitted to a mobile station, comprising the steps of:
dividing a region to which a data burst is allocated into at least one data burst sub-region and constructing the DL frame with the at least one data burst sub-region such that a power boosting process is performed;
allocating the data burst to a specific data burst sub-region of the at least one data burst sub-region according to a carrier to interference and noise ratio (CINR) of the data burst;
computing a slot occupancy rate of data bursts allocated to the specific data burst sub-region;
determining a concatenation or non-concatenation of the data bursts allocated to the specific data burst sub-region when the slot occupancy rate is less than a predefined slot occupancy rate; and
estimating a size of the MAP region to be occupied by allocation information of the data bursts to be concatenated or unconcatenated by the determining.

2. The method of claim 1, wherein the estimating step comprises:
concatenating data bursts of an identical mobile station or data bursts of an identical modulation and coding scheme (MCS) level without concatenating data bursts of different mobile stations or data bursts of different modulation and coding scheme (MCS) levels;
increasing the number of DL MAP information elements (IEs) by the number of unconcatenated data bursts;
determining the number of slots of the MAP region by referring to the set number of DL MAP IEs; and
determining the number of symbols of the MAP region and the number of symbols of a specific data burst allocation region using the number of slots of the MAP region.

3. The method of claim 2, wherein the number of slots of the MAP region is set by:
Number of MAP slots=4+39+4×UL_MAP IE count+4.5×DL_MAP IE count+4×DL_STC ZONE IE+3×UL_STC ZONE IE,
where FCH is a frame control header, STC is space-time coding, a value 4 is the number of slots needed to transmit information bits of the FCH in a MAP, a value 39 is the number of slots needed to transmit additional information bits, for example, information bits of a MAP message length, an operator identifier, a sector identifier, a PHY synchronization field, and so on, a coefficient 4 of the UL_MAP IE count is the number of slots needed to transmit position and MCS level information of a UL burst, a coefficient 4.5 of the DL_MAP IE count is the number of slots needed to transmit position and MCS level information of a DL burst, a coefficient 4 of the DL_STC ZONE IE is a value obtained by computing the number of information bits in a slot unit when at least one of full usage of subchannel (FUSC) and partial usage of subchannel (PUSC) zones is used in a DL sub-frame, and a coefficient 3 of the UL_STC ZONE IE is a value obtained by computing the number of information bits in the slot unit when at least one of the PUSC and FUSC zones is used in a UL sub-frame.

4. The method of claim 2, wherein the number of symbols of the MAP region is set by:
Number of MAP symbols =ceiling (Number of MAP Slots/30)×2, and the number of symbols of the specific data burst allocation region is set by:
Number of Data burst symbols =Number of Frame symbols−(Number of Preamble symbols (1)+Number of MAP symbols).

5. The method of claim 1, further comprising:
stopping data burst allocation to the specific data burst sub-region when the slot occupancy rate is more than the predefined slot occupancy rate.
